(19) United States
(12) Patent Application Publication
(10) Pub. No.: US 2015/0358277 A1
(43) Pub. Date: Dec. 10, 2015

(54) COMMUNICATION TERMINAL AND STORAGE MEDIUM

(71) Applicant: KYOCERA CORPORATION, Kyoto-shi, Kyoto (JP)

(72) Inventor: Kazuo ONISHI, Yokohama-shi, Kanagawa (JP)

(73) Assignee: KYOCERA CORPORATION, Kyoto-shi, Kyoto (JP)

(21) Appl. No.: 14/760,463

(22) PCT Filed: Jan. 10, 2014
(86) PCT No.: PCT/JP2014/050383

§ 371 Date: Jul. 10, 2015

(30) Foreign Application Priority Data
Jan. 11, 2013 (JP) 2013-004085

(51) Int. Cl. H04L 29/12; G06F 17/30

(52) U.S. Cl. CPC H04L 61/1511; H04L 61/6059; G06F 17/30864

(57) ABSTRACT

A communication terminal and a storage medium storing a program thereon are provided, which do not transmit wasteful queries to a DNS server. A smartphone includes a determination module and a request processing module. When name resolution to an IPv6 address is designated, the determination module determines whether communication is possible with an IPv6 address. In a case of determining that communication is possible with an IPv6 address, the request processing module transmits a query for requesting an IPv6 address. In a case of determining that communication is not possible with an IPv6 address, the request processing module does not transmit the query.

### TECHNICAL FIELD

The present disclosure relates to a communication terminal and a storage medium provided to the communication terminal, which transmit a query for requesting name resolution to an IP address, and which perform data communication using the IP address obtained in response to the query transmitted.

### BACKGROUND ART

In recent years, IPv6 has appeared in addition to IPv4, as versions of IP addresses used in communication protocols of the Internet.

When a communication terminal queries a DNS server to obtain an IPv6 address, the communication terminal transmits a DNS packet called an AAAA query, and obtains the IPv6 address corresponding to a host name in response to the query (for example, refer to Patent Document 1).

Patent Document 1: Japanese Unexamined Patent Application, Publication No. 2012-065350

### DISCLOSURE OF THE INVENTION

### Problems to be Solved by the Invention

However, a communication terminal may support only some functions of IPv6. For example, in a case in which an OS supports IPv6 but a communication module does not support IPv6, even if the communication terminal can obtain an IPv6 address by transmitting an AAAA query, the communication terminal has not been able to actually perform communication by using this IPv6 address.

An object of the present invention is to provide a communication terminal and a storage medium storing a program thereon, which do not transmit a wasteful query to a DNS server.

### Means for Solving the Problems

The communication terminal according to the present disclosure is a communication terminal, which transmits, to a DNS server, a query for requesting name resolution to a first or second version IP address, and performs data communication using the IP address obtained based on a response from the DNS server. The communication terminal includes a determination module and a request processing module. When name resolution to the second version IP address is designated, the determination module determines whether communication is possible with the second version IP address. In a case in which the determination module determines that communication is possible with the second version IP address, the request processing module transmits a query for requesting the second version IP address. In a case in which the determination module determines that communication is not possible with the second version IP address, the request processing module does not transmit the query.

The determination module may refer to a routing table for the second version IP address. In a case in which a default route is set, the determination module may determine that communication is possible with the second version IP address. In a case in which a default route is not set, the determination module may determine that communication is not possible with the second version IP address.

The first version may be IPv4, and the second version may be IPv6.

The non-transitory storage medium according to the present disclosure is a non-transitory storage medium provided to a communication terminal, which transmits, to a DNS server, a query for requesting name resolution to a first or second version IP address, and performs data communication using the IP address obtained based on a response from the DNS server. The non-transitory storage medium stores a program thereon for causing the communication terminal to execute: a determining step of determining whether communication is possible with a second version IP address, when name resolution to the second version IP address is designated; and a request processing step of transmitting a query for requesting the second version IP address, in a case in which the determining step determines that communication is possible with the second version IP address, and of not transmitting the query in a case in which the determining step determines that communication is not possible with the second version IP address. Effects of the Invention

According to the present invention, a communication terminal does not transmit a wasteful AAAA query.

### BRIEF DESCRIPTION OF THE DRAWINGS

FIG. 1 is a perspective view showing an external appearance of a smartphone according to an embodiment;

FIG. 2 is a front view showing the external appearance of the smartphone according to the embodiment;

FIG. 3 is rear view showing the external appearance of the smartphone according to the embodiment;

FIG. 4 is a block diagram showing an arrangement of the smartphone according to the embodiment;

FIG. 5 is a block diagram showing features of a controller according to the embodiment;

FIG. 6 is a first flowchart showing processing of the smartphone according to the embodiment; and

FIG. 7 is a second flowchart showing processing of the smartphone according to the embodiment.

### PREFERRED MODE FOR CARRYING OUT THE INVENTION

An example of embodiments for carrying out the present invention is described in detail with reference to the drawings. Hereinafter, a smartphone will be described as an example of a communication terminal.

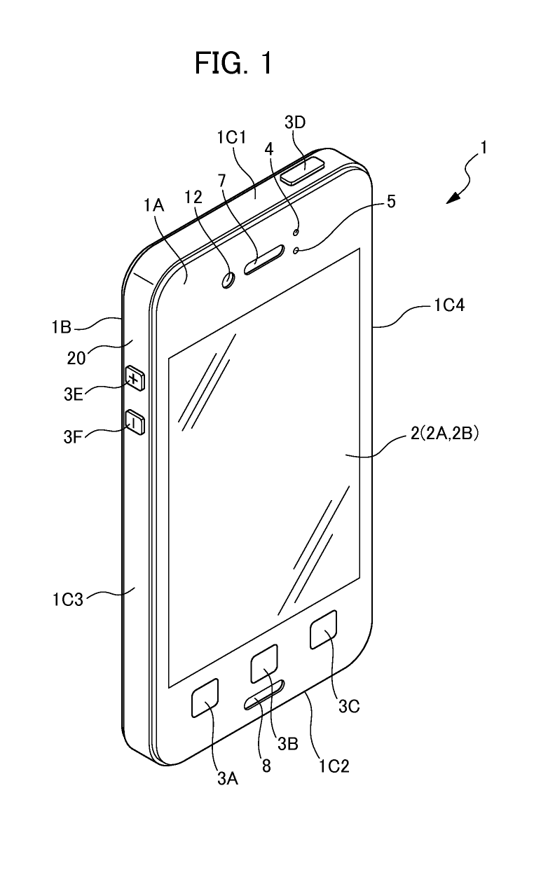

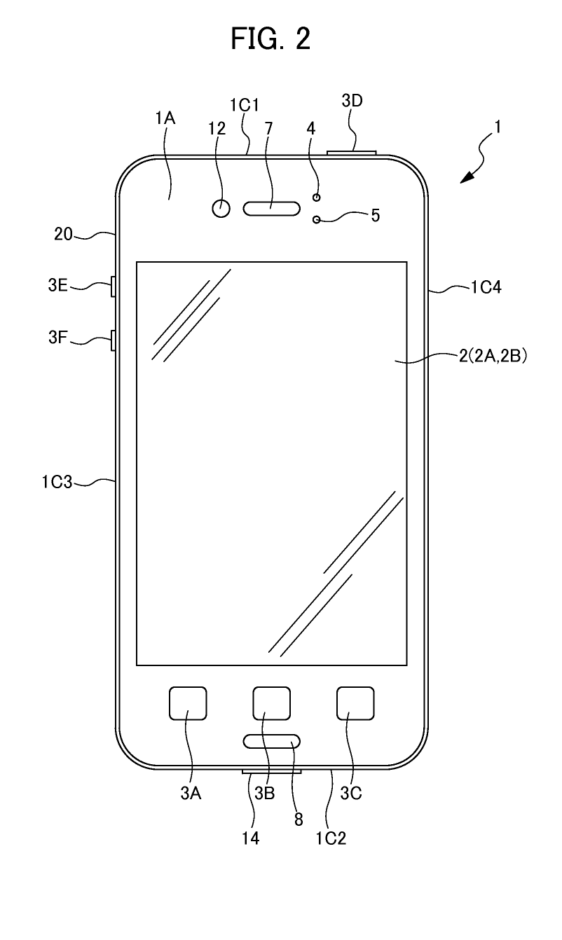

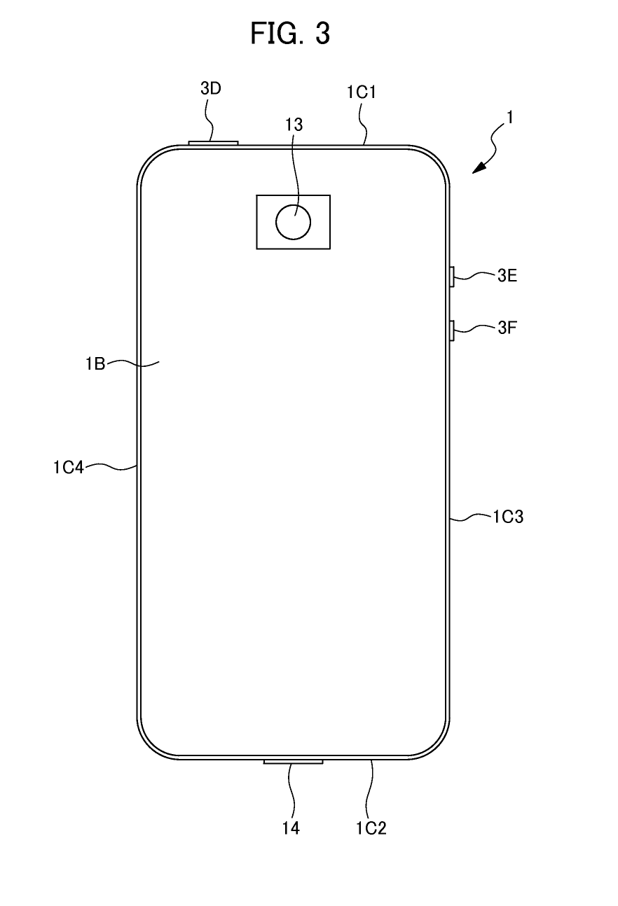

Descriptions are provided for an external appearance of a smartphone 1 according to the embodiment with reference to FIGS. 1 to 3. As shown in FIGS. 1 to 3, the smartphone 1 has a housing 20. The housing 20 has a front face 1A, a back face 1B, and side faces 1C1 to 1C4. The front face 1A is a front face of the housing 20. The back face 1B is a back face of the housing 20. The side faces 1C1 to 1C4 are side faces that connect the front face 1A and the back face 1B. In the following descriptions, the side faces 1C1 to 1C4 may be collectively referred to as a side face 1C without specifying which face.

On the front face 1A, the smartphone 1 has a touch-screen display 2, buttons 3A to 3C, an illuminance sensor 4, a proximity sensor 5, a receiver 7, a microphone 8, and a camera 12. The smartphone 1 has a camera 13 in the back face 1B. The smartphone 1 has buttons 3D to 3F and an external interface 14 in the side face 1C. In the following descriptions, the buttons 3A to 3F may be collectively referred to as a button 3 without specifying which button.

The touch-screen display 2 has a display 2A and a touch screen 2B. The display 2A includes a display device such as a liquid crystal display, an organic EL (electro-luminescence) panel, or an inorganic EL panel. The display 2A displays characters, images, symbols, graphics or the like.

The touch screen 2B detects a touch by a finger, a stylus pen or the like to the touch-screen display 2. The touch screen 2B detects a position where a plurality of fingers, the stylus pen or the like touch the touch-screen display 2.

A detection method for the touch screen 2B may be any method such as a capacitive sensing method, a resistor film method, a surface acoustic wave method (or an ultrasonic sensing method), an infrared ray method, an electromagnetic induction method, and a load detection method. In the following, for the purpose of simplifying descriptions, the fingers, the stylus pen or the like, touching of which to the touch-screen display 2 is detected by the touch screen 2B, may be simply referred to as a “finger”.

The smartphone 1 distinguishes types of gestures, based on a touch, a touch position(s), a touching period of time, or the number of times touching is done, as detected by the touch screen 2B. The gesture is an operation that is performed on the touch-screen display 2. Gestures that are distinguished by the smartphone 1 include a touch, a long touch, a release, a swipe, a tap, a double tap, a long tap, a drag, a flick, a pinch-in, a pinch-out, and the like.

The touch is a gesture of a finger that touches the touch-screen display 2 (for example, a surface thereof). The smartphone 1 distinguishes the gesture of a finger touching the touch-screen display 2 as a touch. The long touch is a gesture of a finger touching the touch-screen display 2 for more than a certain period of time. The smartphone 1 distinguishes the gesture of a finger touching the touch-screen display 2 for more than a certain period of time as a long touch.

The release is a gesture of a finger being released from the touch-screen display 2. The smartphone 1 distinguishes the gesture of a finger being released from the touch-screen display 2 as a release. The swipe is a gesture of a finger moving while touching the touch-screen display 2. The smartphone 1 distinguishes the gesture of a finger moving while touching the touch-screen display 2 as a swipe.

The tap is a consecutive gesture of touch and release. The smartphone 1 distinguishes the consecutive gesture of touch and release as a tap. The double tap is a gesture of repeating a consecutive gesture of touch and release two times. The smartphone 1 distinguishes the gesture of repeating a consecutive gesture of touch and release two times as a double tap.

The long tap is a consecutive gesture of a long touch and release. The smartphone 1 distinguishes the consecutive gesture of a long touch and release as a long tap. The drag is a gesture of swiping from a starting point where a movable object is displayed. The smartphone 1 distinguishes the gesture of swiping from a starting point where a movable object is displayed as a drag.

The flick is a consecutive gesture of touch and release of a finger moving at a high-speed in one direction. The smartphone 1 distinguishes the gesture of touch and release of a finger moving at a high-speed in one direction as a flick. The flick includes: an upward flick of a finger moving in an upward direction on the screen; a downward flick of a finger moving in a downward direction on the screen; a rightward flick of a finger moving in a rightward direction on the screen; a leftward flick of a finger moving in a leftward direction on the screen; and the like.

The pinch-in is a gesture of a plurality of fingers swiping in mutually approaching directions. The smartphone 1 distinguishes the gesture of a plurality of fingers swiping in mutually approaching directions as a pinch-in. The pinch-out is a gesture of a plurality of fingers swiping in mutually receding directions. The smartphone 1 distinguishes the gesture of a plurality of fingers swiping in mutually receding directions as a pinch-out.

The smartphone 1 is operated in accordance with these gestures that are distinguished via the touch screen 2B. Therefore, intuitive and easy-to-use operability is achieved for a user. An operation, which is performed by the smartphone 1 in accordance with a gesture thus distinguished, is different depending on the screen that is displayed on the touch-screen display 2.

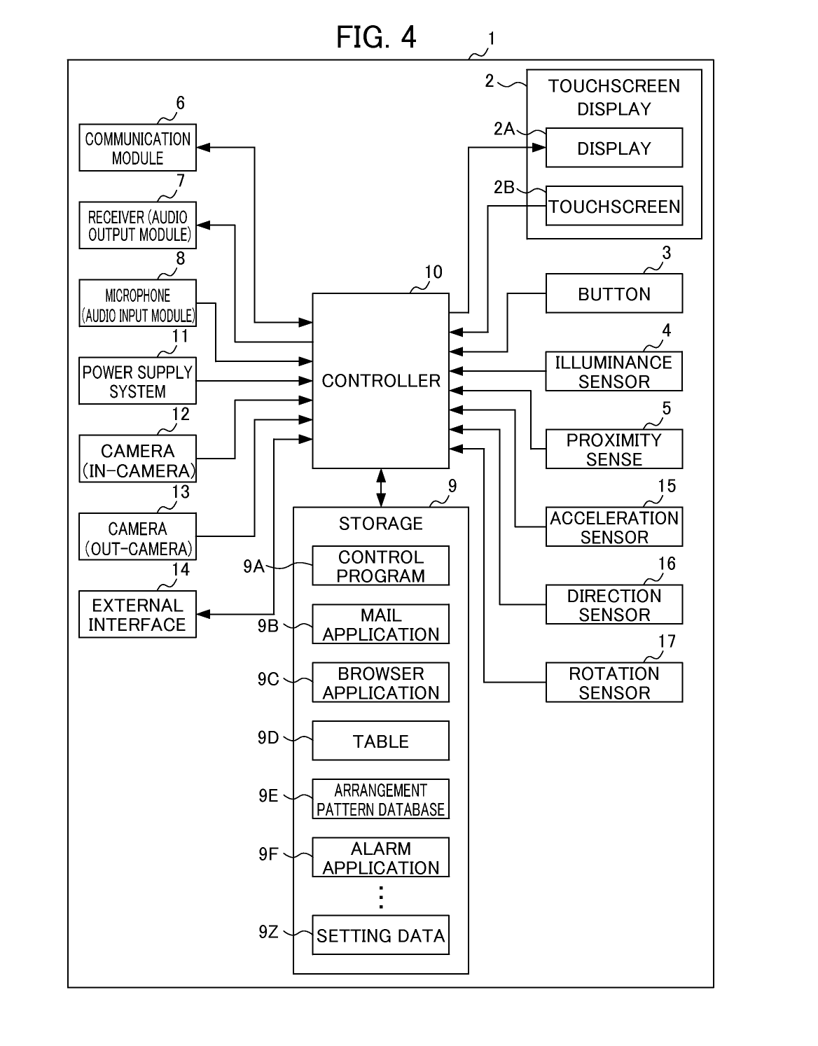

FIG. 4 is a block diagram showing an arrangement of the smartphone 1. The smartphone 1 has the touch-screen display 2, the button 3, the illuminance sensor 4, the proximity sensor 5, a communication module 6, the receiver 7, the microphone 8, a storage 9, a controller 10, cameras 12 and 13, an external interface 14, an acceleration sensor 15, a direction sensor 16, and a rotation detection sensor 17.

As described above, the touch-screen display 2 has the display 2A and the touch screen 2B. The display 2A displays characters, images, symbols, graphics or the like. The touch screen 2B detects a gesture.

The button 3 is operated by the user. The button 3 has the buttons 3A to 3F. The controller 10 collaborates with the button 3 to detect an operation of the button. The operation of the button is, for example, a click, a double click, a push, and a multi-push.

For example, the buttons 3A to 3C are a home button, a back button or a menu button. For example, the button 3D is a power on/off button of the smartphone 1. The button 3D may also serve as a sleep/wake-up button. For example, the buttons 3E and 3F are volume buttons.

The illuminance sensor 4 detects illuminance. For example, the illuminance is intensity, brightness, brilliance, etc. of light. For example, the illuminance sensor 4 is used for adjusting the brilliance of the display 2A.

The proximity sensor 5 detects presence of a proximate object in a contactless manner. The proximity sensor 5 detects, for example, a face being brought close to the touch-screen display 2.

The communication module 6 performs wireless communication. Communication schemes implemented by the communication module 6 are wireless communication schemes. For example, the wireless communication schemes include cellular phone communication schemes such as 2G, 3G and 4G. For example, the cellular phone communication schemes include LTE (Long Term Evolution), W-CDMA, CDMA2000, PDC, GSM, PHS (Personal Handy-phone System), etc. For example, the wireless communication schemes include WiMAX (Worldwide Interoperability for Microwave Access), IEEE 802.11, Bluetooth, IrDA, NFC (Near Field Communication), etc. Communication module 6 may support one or more of the communication schemes described above.

When a sound signal is transmitted from the controller 10, the receiver 7 outputs the sound signal as sound. The microphone 8 converts sound such as the user's voice into a sound signal, and transmits the sound signal to the controller 10. The smartphone 1 may further have a speaker(s) in addition to the receiver 7. The smartphone 1 may further have a speaker(s) in place of the receiver 7.

The storage 9 stores programs and data. The storage 9 is also utilized as a working area for temporarily storing processing results of the controller 10. The storage 9 may include an arbitrary storage device such as a semi-conductor storage device and a magnetic storage device. The storage 9 may include several types of storage devices. The storage 9 may include a combination of a portable storage medium such as a memory card with a reader for the storage medium.

The programs stored in the storage 9 include: applications that are executed in the foreground or the background; and a control program that assists operations of the applications. For example, an application causes the display 2A to display a predetermined screen, and causes the controller 10 to execute processing in accordance with a gesture detected by the touch screen 2B. The control program is, for example, an OS. The applications and the control program may be installed in the storage 9 via wireless communication by the communication module 6 or via a storage medium.

The storage 9 stores, for example, a control program 9A, a mail application 9B, a browser application 9C, and setting data 9Z. The mail application 9B provides electric mail functions of creating, transmitting, receiving and displaying electric mail. The browser application 9C provides a web browsing function of displaying web pages. A table 9D stores various tables such as a key assignment table. An arrangement pattern database 9E stores patterns of arrangement such as arrangement of icons displayed on the display 2A. The setting data 9Z provides various set-up functions regarding operations of the smartphone 1.

The control program 9A provides functions regarding a variety of control for operating the smartphone 1. For example, the control program 9A implements a telephone call function by controlling the communication module 6, the receiver 7, the microphone 8, etc. The functions provided by the control program 9A include functions of executing a variety of control such as changing the information displayed on the display 2A in accordance with a gesture detected via the touch screen 2B. The functions provided by the control program 9A may be utilized in combination with functions provided by other programs such as the mail application 9B.

The controller 10 is, for example, a CPU (Central Processing Unit). The controller 10 may be an integrated circuit such as a SoC (System-on-a-chip) that integrates other constituent elements such as the communication module 6. The controller 10 comprehensively controls the operations of the smartphone 1 to implement various functions.

More specifically, the controller 10 implements various functions by referring to data stored in the storage 9 as necessary, executing instructions included in a program stored in the storage 9, and controlling the display 2A, the communication module 6, etc. The controller 10 may change the control in accordance with a result of detection by various detecting modules such as the touch screen 2B, the button 3 and the acceleration sensor 15.

For example, the controller 10 executes the control program 9A to execute a variety of control such as changing the information displayed on the display 2A in accordance with a gesture detected via the touch screen 2B.

The camera 12 is an in-camera that photographs an object from a side of the front face 1A. The camera 13 is an out-camera that photographs an object from a side of the back face 1B.

The external interface 14 is a terminal to which another device is connected. The external interface 14 may be a universal terminal such as USB (Universal Serial Bus), HDMI (High-Definition Multimedia Interface), Light Peak (which may be called Thunderbolt), or an earpiece-microphone connector. The external interface 14 may be a terminal designed for exclusive use, such as a Dock connector. A device that is connected to the external interface 14 includes, for example, an external storage, a speaker, and a communication device.

The acceleration sensor 15 detects a direction and a level of acceleration that acts on the smartphone 1. The direction sensor 16 detects an orientation of geomagnetism. The rotation detection sensor 17 detects rotation of the smartphone 1. Results of such detection by the acceleration sensor 15, the direction sensor 16 and the rotation detection sensor 17 are utilized in combination to detect change in the position and posture of the smartphone 1.

The smartphone 1 as thus constituted performs communication by accessing the Internet, based on a certain communication scheme. The following descriptions assume that the certain communication scheme is Wi-Fi in conformity to IEEE 802.11, and that the smartphone 1 connects to the Internet via an access point.

The smartphone 1 transmits a query for requesting name resolution to a DNS server, for a first version IP address (hereinafter defined as IPv4) or a second version IP address (hereinafter defined as IPv6), and performs data communication by using the IP address obtained based on a response to the query.

Here, the query for requesting an IPv4 address is an A query, and the query for requesting an IPv6 address is an AAAA query.

These queries are transmitted in IPv4 packets. Therefore, these queries can be transmitted even if the smartphone 1 does not support IPv6 communication; and the smartphone 1 can obtain an IPv6 address in response to a query thus transmitted.

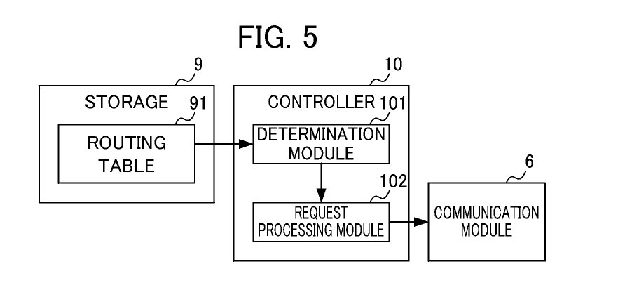

FIG. 5 is a block diagram showing features of the controller 10 according to the present embodiment.

The controller 10 includes a determination module 101 and a request processing module 102.

When an application designates name resolution to an IPv6 address, the determination module 101 determines whether communication is possible with this IPv6 address.

More specifically, by referring to a routing table 91 stored in the storage 9 or another storage medium, in a case in which a default route for IPv6 is set, the determination module 101 determines that communication is possible with an IPv6 address; and in a case in which a default route for IPv6 is not set, the determination module 101 determines that communication is not possible with an IPv6 address.

In a case in which the determination module 101 determines that communication is possible with an IPv6 address, the request processing module 102 transmits an AAAA query for requesting an IPv6 address by way of the communication module 6. On the other hand, in a case in which the determination module 101 determines that communication is not possible with an IPv6 address, the request processing module 102 does not transmit an AAAA query.

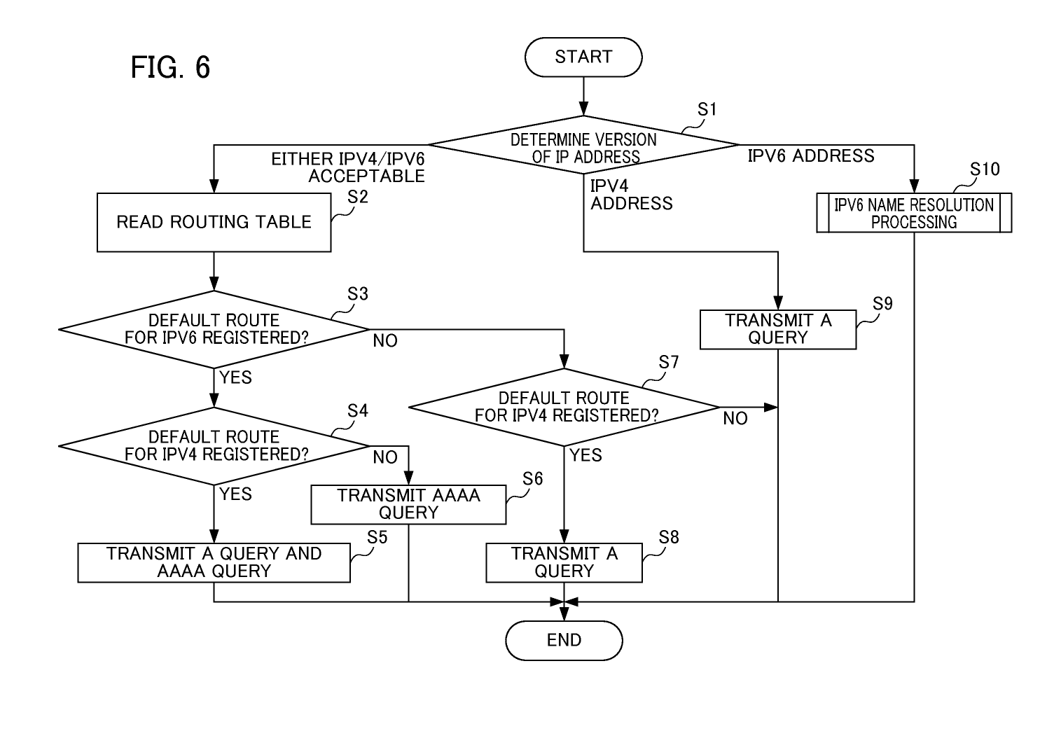

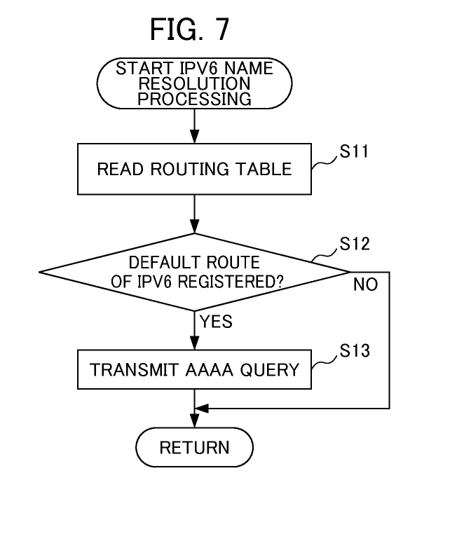

FIGS. 6 and 7 are flowcharts showing processing of the smartphone 1 according to the present embodiment.

The present processing is executed in a case in which a request for name resolution of a domain name occurs in an application that is executed by the controller 10.

In Step S1, the determination module 101 determines the version of a requested IP address. In a case in which either IPv4 or IPv6 is acceptable, the processing advances to Step S2. In a case in which an IPv4 address is requested, the processing advances to Step S9. In a case in which an IPv6 address is requested, the processing advances to Step S10.

In Step S2, the determination module 101 reads the routing table 91 to obtain respective default routes of IPv4 and IPv6.

In Step S3, the determination module 101 determines whether a default route for IPv6 is registered. In a case in which the determination is YES, the determination module 101 determines that communication is possible with IPv6, and advances the processing to Step S4. On the other hand, in a case in which the determination is NO, the determination module 101 determines that communication is not possible with IPv6, and advances the processing to Step S7.

In Step S4, the determination module 101 determines whether a default route for IPv4 is registered. In a case in which the determination is YES, the determination module 101 determines that communication is possible with IPv4, and advances the processing to Step S5. On the other hand, in a case in which the determination is NO, the determination module 101 determines that communication is not possible with IPv4, and advances the processing to Step S6.

In Step S5, since it has been determined that communication is possible with IPv4 and IPv6, the request processing module 102 transmits an A query for IPv4 and an AAAA query for IPv6 to a DNS server.

In Step S6, since it has been determined that communication is possible with only an IPv6 address, the request processing module 102 transmits an AAAA query for IPv6 to a DNS server.

In Step S7, the determination module 101 determines whether a default route for IPv4 is registered. In a case in which the determination is YES, the determination module 101 determines that communication is possible with IPv4, and advances the processing to Step S8. On the other hand, in a case in which the determination is NO, the determination module 101 determines that communication is not possible with IPv4. In this case, a query is not transmitted to a DNS server, and the request processing module 102 notifies the requestor application that the name resolution has failed.

In Step S8, since it has been determined that communication is possible with only an IPv4 address, the request processing module 102 transmits an A query for IPv4 to a DNS server.

In Step S9, the request processing module 102 transmits an A query for IPv4 to a DNS server, in order to obtain a requested IPv4 address.

In Step S10, the controller 10 executes IPv6 name resolution processing (FIG. 7), in order to obtain a requested IPv6 address.

Here, if the request processing module 102 unconditionally transmits an AAAA query for IPv6 to a DNS server, in a case in which the smartphone 1 does not support IPv6 communication, some packets may be wastefully transmitted and received. Accordingly, the controller 10 executes the following processing routine.

In Step S11, the determination module 101 reads the routing table 91 to obtain a default route for IPv6.

In Step S12, the determination module 101 determines whether a default route for IPv6 is registered. In a case in which the determination is YES, the determination module 101 determines that communication is possible with IPv6, and advances the processing to Step S13. On the other hand, in a case in which the determination is NO, the determination module 101 determines that communication is not possible with IPv6. In this case, a query is not transmitted to a DNS server; and the request processing module 102 notifies the requesting application of the fact that the name resolution has failed.

In Step S13, since it has been determined that communication is possible with only an IPv6 address, the request processing module 102 transmits an AAAA query for IPv6 to a DNS server.

According to the present embodiment, in a case in which an IPv6 address, which is a second version IP address, is requested, the smartphone 1 determines whether communication is possible with IPv6; and only in a case in which communication is possible with IPv6, the smartphone 1 transmits an AAAA query. Therefore, in a case in which the smartphone 1 is capable of transmitting an AAAA query for an IPv6 address, but is not capable of performing communication using this IPv6 address, the smartphone 1 can reduce wasteful transmission of AAAA queries. As a result, the load on the smartphone 1 and the load on the network are reduced.

The smartphone 1 refers to the routing table 91, and determines whether communication is possible with IPv6, based on whether a default route for IPv6 is registered. A default route relates to a destination in a case of transmitting a packet to a network other than the network of the terminal itself, with the routing information available. A default route is ordinarily registered to each version supported. Therefore, by determining the presence or absence of such a default route, the smartphone 1 can easily determine whether communication is possible.

The situation in the present embodiment, where an AAAA query can be transmitted but communication is not possible with an IPv6 address, is, for example, a situation where only an OS supports IPv6, but a device (such as the communication module 6) does not support IPv6. In this case, if the OS is modified and reconstructed so as not to support IPv6, a difficulty may occur, for example, in execution of an application that supports both IPv4 and IPv6 versions. According to the present embodiment, the smartphone 1 can control transmission of an AAAA query without any modification of OS functions.

The smartphone 1 has realized an operation of not transmitting an AAAA query in the current Wi-Fi communication, while maintaining the function of transmitting an AAAA query; therefore, if the smartphone 1 supports IPv6 in the future, no modification will be required in the control routine and the OS.

An embodiment of the present invention has been described above, but the present invention is not limited to the embodiment described above. The effects described above in the embodiment of the present invention are merely results describing the most preferable effects that arise from the present invention, and the effects that arise from the present invention are not limited to the effects described in the above embodiment.

The arrangement of the smartphone 1 shown in FIG. 4 is merely an example, and may be modified as appropriate within a scope that does not depart from the spirit of the present invention.

For example, a part or all of the programs stored in the storage 9 as described in FIG. 4 may be downloaded from other devices via wireless communication by the communication module 6. A part or all of the programs stored in the storage 9 as described in FIG. 4 may be stored in a storage medium that is readable by a reader included in the storage 9. A part or all of the programs stored in the storage 9 as described in FIG. 4 may be stored in a storage medium such as a CD, a DVD or a Blu-ray that is readable by a reader connected to the external interface 14.

Each of the programs shown in FIG. 4 may be divided into a plurality of modules, and may be combined with other programs.

In the above embodiment, a smartphone has been described as an example of the communication terminal, but the communication terminal is not limited to a smartphone. For example, the communication terminal may be a portable electronic device such as a mobile phone, a portable personal computer, a digital camera, a media player, a digital book reader, a navigator or a gaming machine, or may be a module dedicated for communication, which is specialized for a communication function. The communication terminal may be a non-portable electronic device such as a desktop PC or a television set.

### EXPLANATION OF REFERENCE NUMERALS

1 smartphone (communication terminal)

6 communication module

9 storage

10 controller

91 routing table

101 determination module

102 request processing module

1. A communication terminal comprising:
a transmitter configured to transmit, to a DNS server, a query for requesting name resolution to a predetermined version IP address, and perform data communication using the IP address obtained based on a response from the DNS server; and
a controller configured to determine whether communication is possible with the predetermined version IP address when name resolution to the predetermined version IP address is designated, wherein
the controller transmits the query when the controller determines that communication is possible with the predetermined version IP address, and does not transmit the query when the controller determines that communication is not possible with the predetermined version IP address.

2. The communication terminal according to claim 1, wherein the controller determines that communication is possible with the predetermined version IP address when a default route for the predetermined version IP address is set, and determines that communication is not possible with the predetermined version IP address when the default route is set.

3. The communication terminal according to claim 1,
wherein the predetermined version is IPv6.

4. A non-transitory storage medium included in a communication terminal configured to transmit, to a DNS server, a query for requesting name resolution to a predetermined version IP address, and perform data communication using the IP address obtained based on a response from the DNS server, the non-transitory storage medium storing a program for causing the communication terminal to execute:
a determining step of determining whether communication is possible with the predetermined version IP address when name resolution to the predetermined version IP address is designated; and
control step of transmitting the query when the determining step determines that communication is possible with the predetermined version IP address; and of not transmitting the query when the determining step determines that communication is not possible with the predetermined version IP address.
